(19) United States
(12) Patent Application Publication
(10) Pub. No.: US 2008/0029496 A1
(43) Pub. Date: Feb. 7, 2008

(54) METHOD FOR MAKING A GOLF CLUB HEAD

(76) Inventors: Chon-Chen Lin, Ping-Tung Hsien (TW); Shun-Fu Hu, Ping-Tung Hsien (TW); Yen-Chi Hsu, Ping-Tung Hsien (TW)

Correspondence Address: OSTROLENK FABER GERB & SOFFEN, 1180 AVENUE OF THE AMERICAS, NEW YORK, NY, 100368403, US

(21) Appl. No.: 11/461,609

(22) Filed: Aug. 1, 2006

(51) Int. Cl. B23K 26/24; B23K 26/30; B23K 26/12

(52) U.S. Cl. 219/121.64; 219/121.86

(57) ABSTRACT

A method for making a golf club head includes the steps: of preparing a first golf club head component having a first bonding edge defining an opening, and a second golf club head component made of a material different from that of the first golf club head component and having a second bonding edge; placing the second golf club head component in the opening of the first golf club head component with the first bonding edge surrounding the second bonding edge; placing a solder between the first and second bonding edges; placing the first and second golf club head components and the solder in a chamber filled with an inert gas; and welding the first bonding edge to the second bonding edge by heating the solder using a laser beam.

### BACKGROUND OF THE INVENTION

1. Field of the Invention

The invention relates to a method for making a golf club head, more particularly to a method for making a golf club head by welding with a laser beam.

2. Description of the Related Art

Conventionally, a golf club head is made by preparing two golf club head components, such as a head casing and a striking plate, and bonding the golf club head components to each other by gluing or by brazing.

Taiwanese Patent Publication No. 327,606 discloses a method for bonding a golf club head casing to a striking plate by brazing. The method includes the steps of: placing a brazing material, such as a copper paste, in a groove of the golf club head casing made of stainless steel; embedding the striking plate made of a titanium alloy in the golf club head casing; and placing and heating the golf club head casing, the striking plate, and the brazing material in a vacuum furnace or a furnace filled with an inert gas at a temperature ranging from 750 to 1100° C., preferably at a temperature of 1050° C., for a period of 4 to 5 hours so as to melt the brazing material and bond the golf club head casing to the striking plate via the brazing material. The brazing material used in this prior art should have a melting point lower than those of the golf club head casing and the striking plate.

The disadvantages of the prior art are as follows:

1) Since the golf club head casing and the striking plate are heat-treated in the furnace at an elevated temperature for a relatively long period of time, the physical and mechanical properties of the golf club head casing and the striking plate after the treatment will be changed or even be degraded.

2) Since the brazing material used in this prior art is required to have a melting point lower than those of the golf club head casing and the striking plate, the variety of the suitable brazing material is limited.

3) Since the heat-treating and cooling times required in the prior art are relatively long, the productivity of the prior art is unsatisfactory.

### SUMMARY OF THE INVENTION

The object of the present invention is to provide a method for making a golf club head by welding with a laser beam.

Accordingly, the method of this invention includes the steps: of preparing a first golf club head component having a first bonding edge defining an opening, and a second golf club head component made of a material different from that of the first golf club head component and having a second bonding edge; placing the second golf club head component in the opening of the first golf club head component with the first bonding edge surrounding the second bonding edge; placing a solder between the first and second bonding edges; placing the first and second golf club head components and the solder in a chamber filled with an inert gas; and welding the first bonding edge to the second bonding edge by heating the solder using a laser beam.

### BRIEF DESCRIPTION OF THE DRAWINGS

Other features and advantages of the present invention will become apparent in the following detailed description of the preferred embodiment with reference to the accompanying drawings, of which:

FIG. 1 is a flow chart of the preferred embodiment of a method for making a golf club head according to this invention;

FIG. 2 is an exploded perspective view of a first example of the golf club head to be made according to the preferred embodiment;

FIG. 3 is a schematic sectional view illustrating how a golf club head is made according to the preferred embodiment;

FIG. 4 is an exploded perspective view of a second example of the golf club head to be made according to the preferred embodiment;

FIG. 5 is a sectional view of the second example of the golf club head;

FIG. 6 is an exploded perspective view of a third example of the golf club head to be made according to the preferred embodiment;

FIG. 7 is a sectional view of the third example of the golf club head;

FIG. 8 is an exploded perspective view of a fourth example of the golf club head to be made according to the preferred embodiment; and

FIG. 9 is a sectional view of the fourth example of the golf club head.

### DETAILED DESCRIPTION OF THE PREFERRED EMBODIMENT

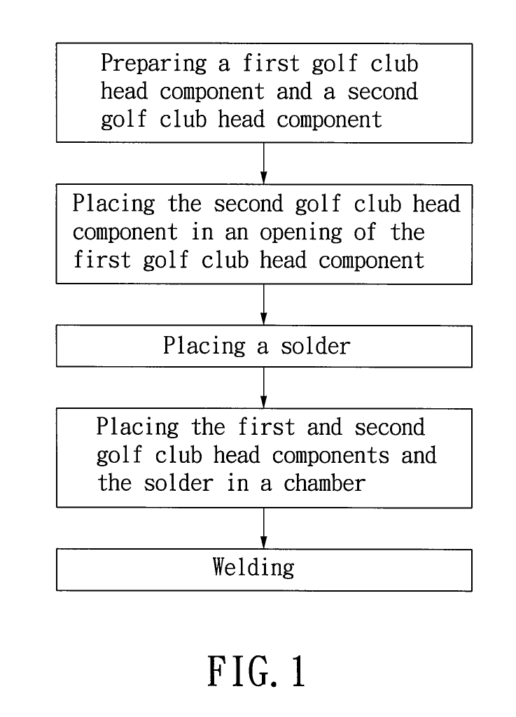

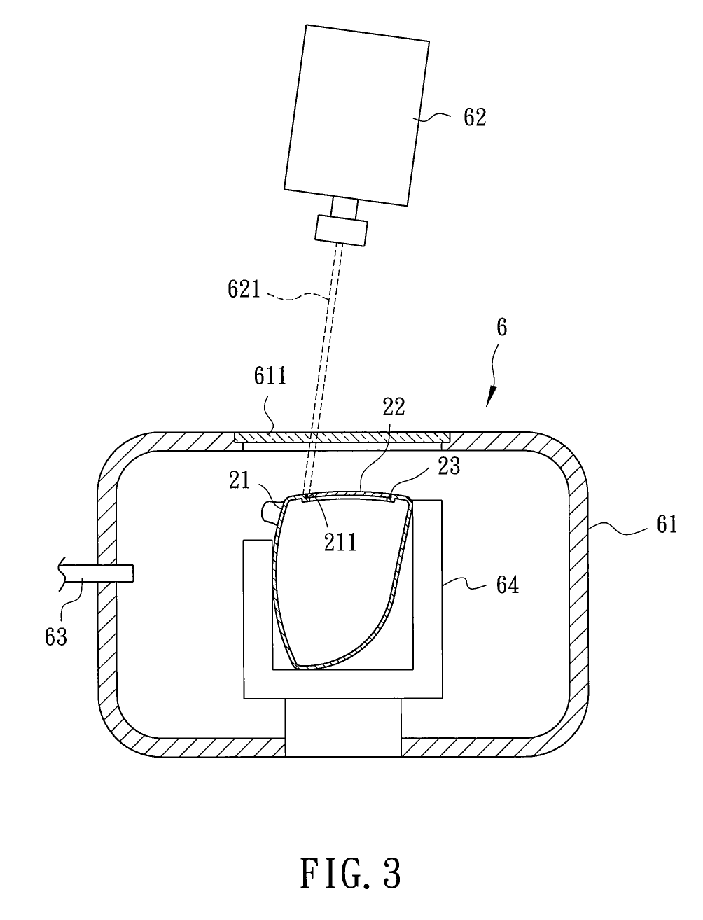

Referring to FIGS. 1, 2 and 3, the preferred embodiment of a method for making a golf club head 2 according to this invention is shown to include the steps of:

A) preparing a first golf club head component and a second golf club head component:

A golf club head 2 to be made according to this invention can be an iron head, a wood head or a putter head. The golf club head 2 is made from a first golf club head component 21 and a second golf club head component 22. The first golf club head component 21 has a first bonding edge 212 defining an opening 211. The second golf club head component 22 is made of a material different from that of the first golf club head component 21 and has a second bonding edge 221. In the preferred embodiment, the first golf club head component 21 is made of stainless steel, and the second golf club head component 22 is made of a titanium alloy. Other suitable materials, such as carbon steel, alloy steel, a titanium alloy, an aluminum alloy, an aluminum-selenium alloy, an aluminum-scandium alloy, an aluminum-magnesium alloy, a copper alloy, a zirconium alloy, a tungsten alloy, and a metal-containing composite, can be used for making the first golf club head component 21. Moreover, the second golf club head component 22 can also be made of any one of the aforesaid suitable materials as long as the second golf club head component 22 is made of a material different from that of the first golf club head component 21.

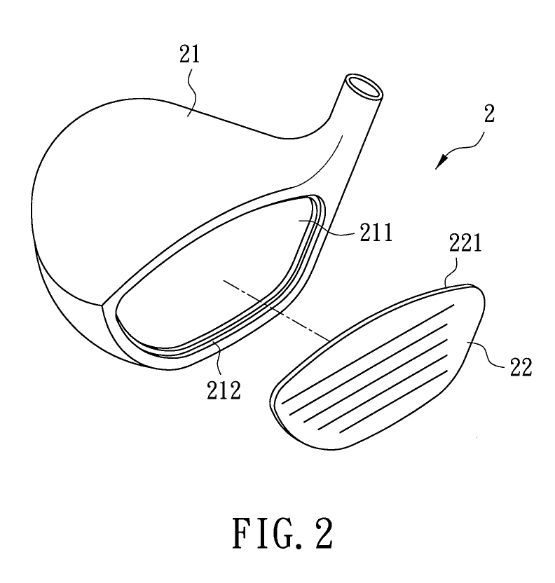

As shown in FIG. 2, in the first example of the golf club head 2 to be made according to this invention, the first golf club head component 21 is a head casing having a front side formed with the opening 211, and the second golf club head component 22 is a striking plate.

B) placing the second golf club head component in the opening of the first golf club head component:

The second golf club head component 22 is placed in the opening 211 of the first golf club head component 21 with the first bonding edge 212 surrounding the second bonding edge 221.

C) placing a solder:

A solder 23 is placed between the first and second bonding edges 212, 221. The material suitable for the solder 23 can be an aluminum-based alloy, a copper-based alloy, or a nickel-based alloy. The solder 23 can be provided in a powdery, pasty, strip-like, sheet-like, or rod-like form.

D) placing the first and second golf club head components and the solder in a chamber:

The first and second golf club head components 21, 22 and the solder 23 are placed in a welding device 6, which includes a chamber 61, a gas supplying member 63 for supplying an inert gas into the chamber 61, a positioning member 64 mounted in the chamber 61 for positioning the first and second golf club head components 21, 22 thereon, and a laser light generator 62 mounted outside the chamber 61 for generating a laser light beam 621. The chamber 61 is provided with a glass window 611 that permits transmission of the laser light beam 621 from the laser light generator 62 to the first and second golf club head components 21, 22 and the solder 23 therethrough.

In the preferred embodiment, the laser light generator 62 has a power ranging from 2000 to 5000 watts, and generates a laser light beam having a wavelength ranging from 808 to 940 nm. The traveling path of the laser light beam 621 on the first and second golf club head components 21, 22 and the solder 23 can be controlled precisely through movement of the laser light generator 62 relative to the chamber 61 or movement of the positioning member 64 relative to the chamber 61 in one of linear and rotary directions.

The inert gas is used to discharge air out of the chamber 61 and to prevent oxidation from occurring during the welding process. The inert gas suitable for this invention is nitrogen, helium, or argon.

E) welding:

In the chamber 61 filled with the inert gas, the first bonding edge 212 of the first golf club head component 21 is welded to the second bonding edge 221 of the second golf club head component 22 by irradiating and melting the solder 23 using the laser beam 621 from the laser light generator 62. The irradiating operation is usually performed at an ambient temperature.

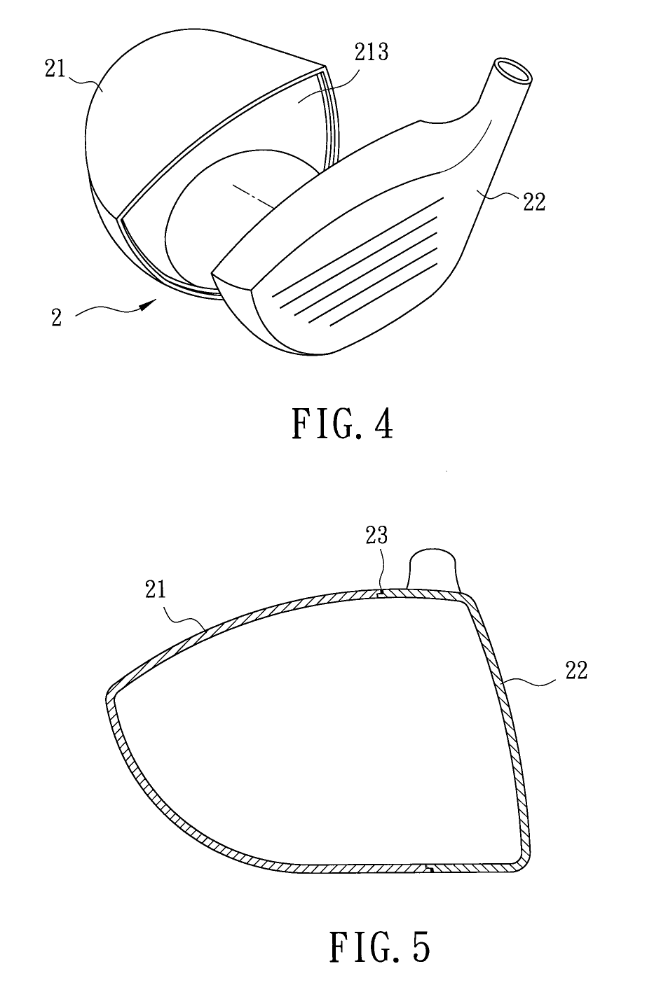

Referring to FIGS. 4 and 5, in the second example of the golf club head 2 to be made by the method of this invention, the first golf club head component 21 is formed as a head casing having a front side with an opening 213, and the second golf club head component 22 is formed as a cup-shaped striking body.

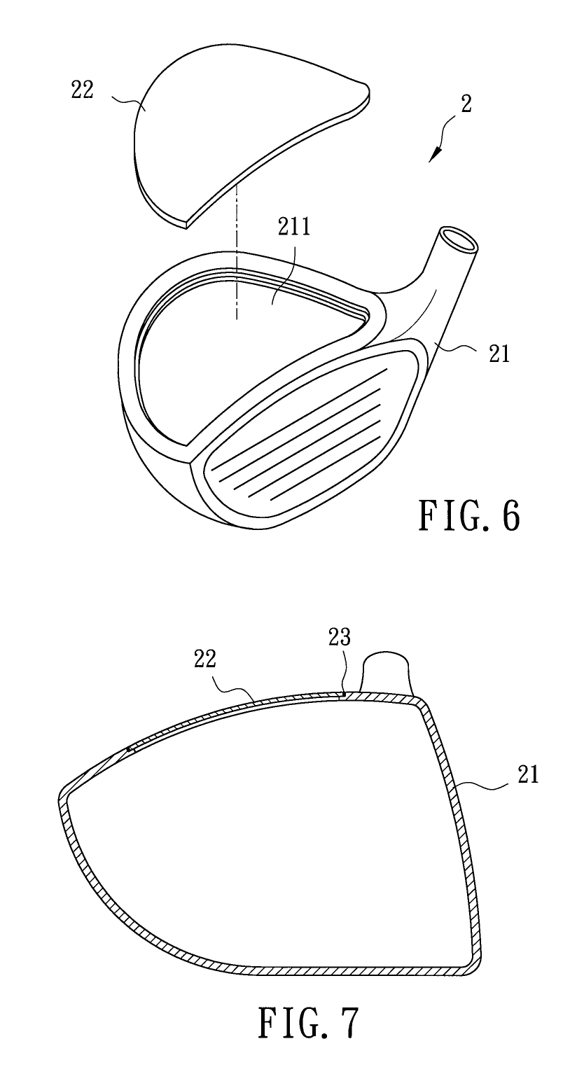

Referring to FIGS. 6 and 7, in the third example of the golf club head 2 to be made by the method of this invention, the opening 211 of the first golf club head component 21 is formed at a top side of the first golf club head component 21, and the second golf club head component 22 is formed as a top cover plate.

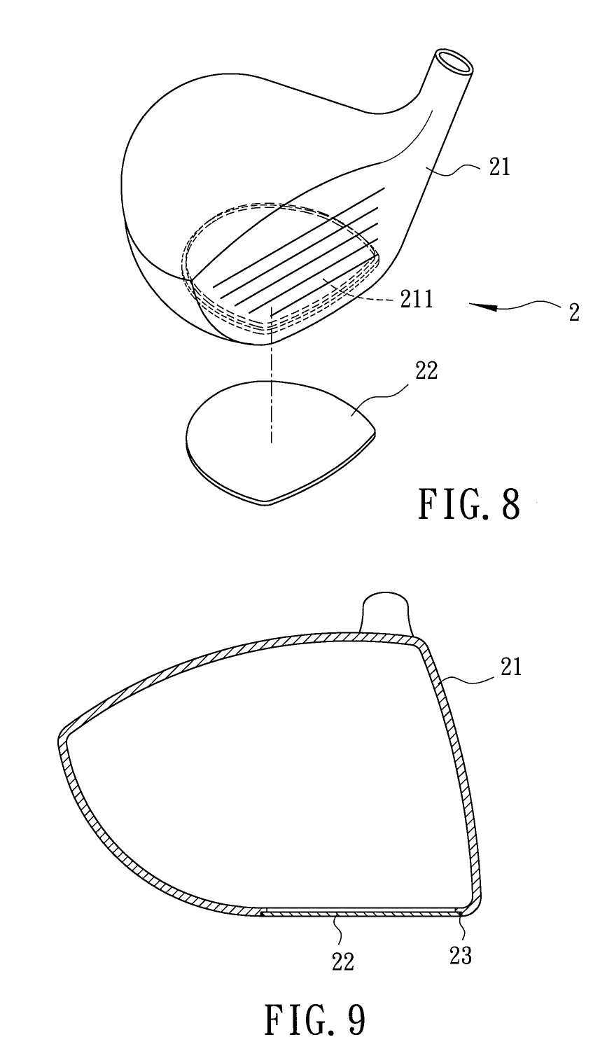

Referring to FIGS. 8 and 9, in the fourth example of the golf club head 2 to be made by the method of this invention, the opening 211 of the first golf club head component 21 is formed at a bottom side of the first golf club head component 21, and the second golf club head component 22 is formed as a bottom cover plate.

In view of the aforesaid, the method of this invention has the following advantages:

1). Since the first and second golf club head components 21, 22 are welded together at an ambient temperature via precise irradiation with the laser light beam 341 to melt the solder 23, the original physical and mechanical properties of the non-irradiated areas of the first and second golf club head components 21, 22 can be maintained.

2) Since the solder 23 is melted by irradiating with the laser light beam 621, rather than by heating the solder 23 and the first and second golf club head components 21, 22 together, the variety of the suitable material for the solder 23 is relatively flexible, and the operation period for the method of this invention can be reduced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for making a golf club head, comprising the steps of:
preparing a first golf club head component having a first bonding edge defining an opening, and a second golf club head component made of a material different from that of the first golf club head component and having a second bonding edge;
placing the second golf club head component in the opening of the first golf club head component with the first bonding edge surrounding the second bonding edge;
placing a solder between the first and second bonding edges;
placing the first and second golf club head components and the solder in a chamber filled with an inert gas; and
welding the first bonding edge to the second bonding edge by heating the solder using a laser beam at an ambient temperature.

2. The method as claimed in claim 1, wherein the laser beam is generated by a laser generator having an output power ranging from 2000 to 5000 watts, and has a wavelength ranging from 808 to 940 nm.

3. The method as claimed in claim 1, wherein the first golf club head component is a head casing having a front side formed with the opening, and the second golf club head component is a striking plate.

4. The method as claimed in claim 1, wherein each of the first and second golf club head components is made of a material selected independently from the group consisting of stainless steel, carbon steel, alloy steel, a titanium alloy, an aluminum alloy, an aluminum-selenium alloy, an aluminum-scandium alloy, an aluminum-magnesium alloy, a copper alloy, a zirconium alloy, a tungsten alloy, and a metal-containing composite.

5. The method as claimed in claim 1, wherein the solder is selected from the group consisting of an aluminum-based alloy, a copper-based alloy, and a nickel-based alloy.
